(19) United States
(12) Patent Application Publication
(10) Pub. No.: US 2004/0070324 A1
(43) Pub. Date: Apr. 15, 2004

(54) Fluorescent lamp electrode for instant start and rapid start circuits

(76) Inventor: Igor V. Lisitsyn, Chagrin Falls, OH (US)

Correspondence Address: Timothy E. Nauman, FAY, SHARPE, FAGAN, MINNICH & McKEE, LLP, 7th Floor, 1100 Superior Avenue, Cleveland, OH, 44114, US

(21) Appl. No.: 10/627,912

(22) Filed: Jul. 25, 2003

Related U.S. Application Data
(63) Continuation-in-part of application No. 10/080,070, filed on Feb. 21, 2002.

(51) Int. Cl. H01J 1/88

(52) U.S. Cl. 313/271

(57) ABSTRACT

A fluorescent lamp (10) with improved life is formed by winding a coil (30) using first, and second mandrels (45, 46), and optionally a third mandrel (70). The coil is wound around the second mandrel to provide a coil density of at least 95%. The coil is able to carry an amount of emitter material of about 0.6-1.6 mg/cm of coil. This has been found to lead to substantially increased lamp life, on both instant and rapid start circuits.

This application claims the benefit, as a Continuation-in-Part application of U.S. application Ser. No.10/080,070, filed on Feb. 21, 2002, the specification of which is incorporated herein in its entirety.

### BACKGROUND OF THE INVENTION

The present invention relates generally to fluorescent lamps and more particularly to a cathode for a low pressure mercury vapor discharge fluorescent lamp which is suited to use with both instant start circuits and rapid start circuits.

Fluorescent lamps, as known, include a glass tube coated on the inside with phosphor powders which fluoresce when excited by ultraviolet light. The glass tube is filled with rare gases (such as argon, neon, and krypton) and a small amount of mercury, and operates at a relatively low pressure. Electrodes are mounted within the glass tube. The electrodes are coated with an emission mixture, typically comprising carbonates of barium, calcium, and strontium. The carbonates are converted to a ceramic material comprising the corresponding oxides when activated. The emitter material emits electrons during lamp operation. The electrons are accelerated by the voltage across the tube until they collide with mercury atoms, causing the mercury atoms to be ionized and excited. When the mercury atoms return to their normal state, photons corresponding to mercury spectral lines in both the visible and ultraviolet region are generated, thereby exciting the phosphor coating on the inside of the tube to luminance.

To start a fluorescent lamp, electron emission from the electrodes may be induced in several ways. In a first method, a filament electrode is heated by passing current through it. Such lamps may be referred to as “preheat” lamps. During initial start-up of the preheat lamp, a starter bulb, which acts as a switch, is closed, thus shorting the electrodes together. Current passes through both electrodes, serving to preheat the electrodes. This makes them more susceptible to emission of electrons. After a suitable time period has elapsed, during which the electrodes have warmed up, the starter bulb opens. An electric potential is thus applied between the two electrodes, resulting in electron current between them, with subsequent operation of the lamp. A relatively high voltage is applied initially for starting purposes. Then a lower voltage is used during normal operation. A reactance is placed in series with the lamp to absorb any difference between the applied and operating voltages, in order to prevent damage to the lamp. The reactance, suitable transformers, capacitors, and other required starting and operating components are contained within a device known as a ballast.

In a second method of starting, a high voltage, which is sufficient to start an electric discharge in the lamp, is applied across the lamp without preheating the electrodes. So-called “instant start” circuits which are commonly used today typically employ this method of starting. Such instant start lamps employ ballasts which are much more energy efficient than older style ballasts which heat the electrodes. Since a current does not pass through the electrodes, instant-start lamp electrodes may have only a single terminal, although two terminals may be provided so that the lamp may be used with instant start or other ballasts. An extremely high starting voltage (e.g., up to 500-800 V) is typically applied at high frequency in order to induce current flow without preheating of the electrodes. The high starting voltage is supplied by a special instant-start ballast.

A third type of lamp is known as the “rapid-start” lamp. A rapid-start ballast contains transformer windings, which continuously provide an appropriate voltage and current for heating of the electrodes. Heating of electrodes permits relatively fast development of an arc from electrode to electrode, using only the applied voltage from the secondary windings present in the ballast.

Due to the cost of the components and the sophisticated enclosed fixtures often used, it is desirable to extend the life of fluorescent lamps to reduce replacement costs. Various ways have been developed to increase life. Ballast designs have been improved to obtain a smoother start of the lamp. High frequency rapid and program start ballasts have been developed which first heat the electrode and then either keep the electrode hot during operation (rapid start) or turn the heater current off (program ballasts). Use of high current or high Rh/Rc rapid start ballasts has been found to increase lamp life.

Changing the gas composition has also been found to improve lamp life. For example, increasing the argon pressure above the standard 2.5 torr has been found to decrease diffusion coefficients of the fluorescent lamp cathode species and hence impedes evaporation of the emitter from the coil. Increasing the fill pressure from 2.5 torr to 2.8 torr, for example, has been found to provide a 20% increase in lamp life. However, the efficiency of the lamp decreases as the fill pressure increases. The higher pressures also negatively affect the lamp starting voltage.

Another way to increase lamp life is to increase the proportion of heavy gases, such as Kr and Xe, in the fill. This decreases the evaporation of the cathode emitter species and increases lamp life. However, changing the gas composition also changes the wattage of the lamp and starting characteristics.

Despite improvements, lamps using rapid start ballasts typically have longer life than those on instant start ballasts. For example, a typical T8 SP Starcoat™ lamp manufactured by General Electric Company is rated at a life of 20,000 hours on a rapid start ballast and 15,000 hours on a conventional instant start ballast (so called T8 lamps have an internal diameter of 1 . . . . T12 lamps have an internal diameter of 1.5.′). In normal use a lamp is replaced every two to four years, depending on the burning cycle. A lamp which lives for 20,000 hours needs replacement less frequently than one which lives for 15,000 hours, reducing costs of replacement.

T8 lamps are gradually replacing T12 lamps as they are inherently more efficient. The T8 lamp operates on a reference circuit at 32.4 W and produces 2850 lumens, while the standard T12 lamp of the same type operates at 40.8 W on the reference circuit and produces 3200 lumens.

Instant start ballasts are generally easier to manufacture than rapid start ballasts. Thus, several current designs of lamps, such as GE's F32T8 Ultra Watt Miser and Ultra Watt Miser XL, are designed for use with instant start ballasts. However, electrodes designed for use with rapid start ballasts are generally unsuited to use with instant start ballasts.

There remains a need for a lamp which operates with an instant start ballast, but which has a lifetime more comparable to or exceeds that of rapid start ballasts. There also remains a need for a lamp which is capable of operating on both instant start and rapid start ballasts.

### SUMMARY OF THE INVENTION

In an exemplary embodiment of the present invention, a discharge lamp is provided. The lamp includes an envelope. A discharge sustaining fill is sealed inside the envelope. First and second electrodes provide a discharge. At least the first electrode includes a current carrying wire and a coil including at least first and second coiled structures. The first coiled structure is formed by winding an overwind wire around a first cylindrical member. The second coiled structure is formed by winding the first coiled structure around a second cylindrical member. The second coiled structure has a coil density of at least 95%. An emitter material is deposited on the coil.

In another exemplary embodiment, a method for forming a coil for a fluorescent lamp is provided. The method includes forming a coil including winding an overwind wire around a current carrying wire to form a first coiled structure. The first coiled structure is wound around a cylindrical member to form a second coiled structure. The second coiled structure has a coil density of at least 95%. The coil is coated with an emitter mix which, when activated, emits electrons when heated.

In another exemplary embodiment, a method for forming a coil for a fluorescent lamp is provided. The method includes forming a coil including winding an overwind wire around a current carrying wire to form a first coiled structure and winding the first coiled structure around a cylindrical member to form a second coiled structure of a first coil density. The second coiled structure is extended to form a coil having a second coil density which is less than the first coil density. The extended coil is coated with an emitter mix which, when activated, emits electrons when heated.

One advantage of at least one embodiment of the present invention is the provision of an electrode with a longer life, thereby increasing the lifetime of a fluorescent lamp in which it is used.

Another advantage of at least one embodiment of the present invention is the provision of a fluorescent lamp for use with an instant start ballast which has a longer useful life.

Another advantage of at least one embodiment of the present invention is the provision of a fluorescent lamp which is capable of operation on both instant start and rapid start ballasts.

Still further advantages of the present invention will become apparent to those of ordinary skill in the art upon reading and understanding the following detailed description of the preferred embodiments.

### BRIEF DESCRIPTION OF THE DRAWINGS

FIG. 1 is a side view in partial section of a lamp according to the present invention;

FIG. 2 is a perspective view of a primary coil and current carrying wire for the lamp of FIG. 1;

FIG. 3 is a perspective view of the primary coil of FIG. 2, wound to produce a secondary coil;

FIG. 4 is a perspective view of the secondary coil of FIG. 3, coated with an emitter material according to a first embodiment of the invention;

FIG. 5 is a perspective view of the secondary coil wound to produce a tertiary coil according to a second embodiment of the invention;

FIG. 6 is a perspective view of the tertiary coil of FIG. 5, coated with an emitter material;

FIG. 7 is a cross sectional view of the secondary coil of FIG. 3 where the coil density exceeds 100%; and

FIG. 8 is a schematic sectional view of a single turn of the triple coil electrode of FIG. 5.

### DETAILED DESCRIPTION OF THE INVENTION

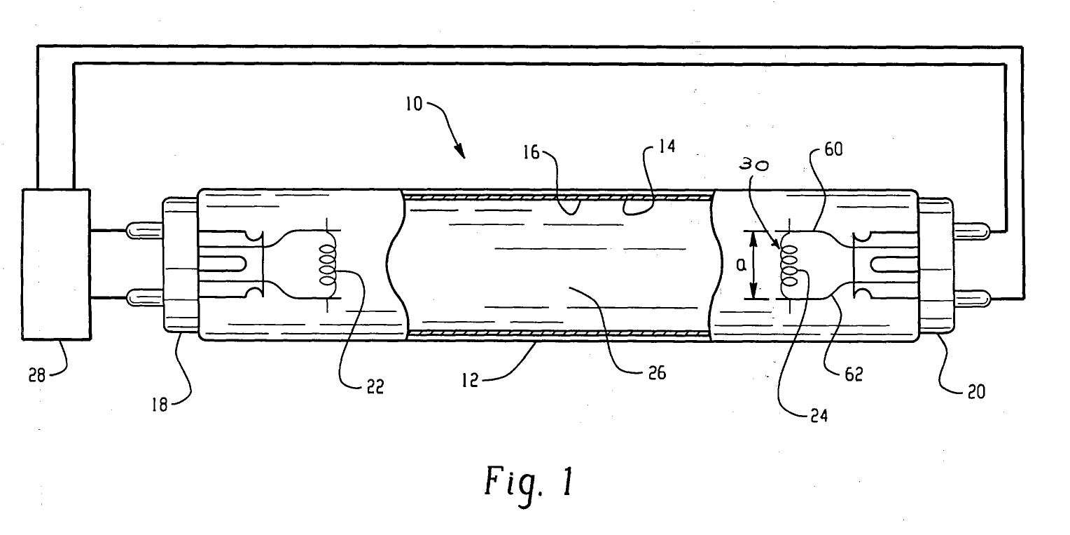

FIG. 1 shows a representative low pressure mercury vapor discharge fluorescent lamp 10. It will be appreciated that a variety of fluorescent lamps may be used with the present invention, including single or double ended lamps, and curved or straight lamps. The fluorescent lamp 10 has a light-transmissive tube or envelope 12 formed from glass or other suitable material, which has a circular cross-section. An inner surface 14 of the glass envelope is provided with a phosphor-containing layer or layers 16. The lamp is hermetically sealed. Bases 18, 20 are attached at ends of the tube, respectively. Two spaced electrodes 22, 24, sometimes referred to as “stick” electrodes are respectively mounted on the bases 18, 20. A discharge-sustaining fill 26, preferably formed from mercury and an inert gas, is sealed inside the glass tube. The inert gas is typically argon or a mixture of argon and other noble gases at low pressure (e.g., 1-4 Torr), which, in combination with a small quantity of mercury, provide the low vapor pressure manner of operation. The lamp is preferably a low pressure mercury vapor discharge lamp, as described, but the invention may also be used in a high pressure mercury vapor discharge lamp.

The phosphor-containing layer or layers 16 typically contain phosphor particles which are known in the art, such as a relatively inexpensive “halo” phosphor which emits a white light, such as a calcium halophosphate activated with antimony and manganese. Rare earth phosphor systems may also be used. These phosphor systems are typically a blend of rare earth phosphors, such as a mixture of red, blue, and green color-emitting phosphors.

The lamp is fitted with a ballast 28 which acts as a starter when the lamp is switched on. In one embodiment, the ballast 28 is an instant start ballast. As is known in the art, the instant start ballast may include electronic circuitry designed to produce a high voltage pulse “instantly” (at around 40 KHz) between the electrodes at a sufficient voltage to cause breakdown of the fill and initiate an arc. Alternatively, the ballast is a rapid-start ballast. The rapid-start ballast contains transformer windings, which continuously provide an appropriate voltage and current for heating of the electrodes and development of an arc from electrode to electrode.

It is also contemplated that other types of ballast may be employed with the present lamp, such as program ballasts, in which case the life of the lamp would be similarly increased by the present invention.

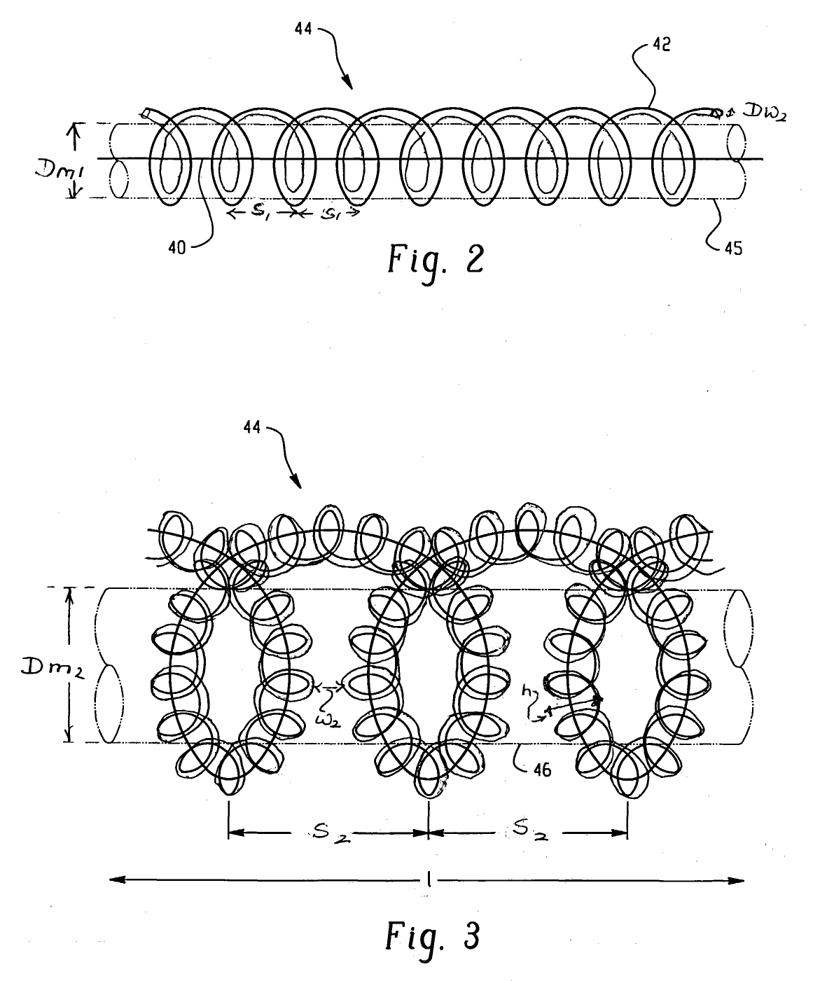

With reference also to FIGS. 2-4, the electrodes 22, 24 each include a coil 30, of overall length a, which is coated with an emitter material 32. The electrodes are preferably similarly formed. As the lamp is used in an alternating circuit, the electrodes alternate in polarity, each one successively becoming the cathode. The emitter material can be formed from one or more carbonates of Group II elements, such as calcium, strontium, and barium carbonates. One specific emitter material comprises a mixture of each of these three carbonates. When activated, the carbonates form a ceramic of the corresponding oxides: barium oxide, strontium oxide, and calcium oxide in the specific embodiment.

For example, to make the coprecipitated carbonate emitter material, a solution of Ba, Sr, and Ca ions is prepared by dissolving the corresponding nitrates or other salts in hot, deionized water. The solution is stirred in a steam jacketed reactor. The carbonates are precipitated by slowly adding an excess of ammonium carbonate or other soluble carbonate salt or by bubbling carbon dioxide through the reactor solution. The result is a precipitate of Ba, Sr, and Ca carbonates. Typical overall compositions are 40-70 wt % equivalent barium carbonate, 30-50 wt % equivalent strontium carbonate and 10-20 wt % equivalent calcium carbonate. There may be several post precipitation processes designed to help form the carbonate precipitate and to concentrate and then remove water from the precipitate. A small amount, e.g., 2-5 wt % zirconium carbonate, may also be precipitated by adding a soluble zirconium salt to the solution before precipitation. In another embodiment, zirconia (zirconium oxide) or zirconium metal is added later. Typically, the coprecipiated carbonate powder after it is dried has a median particle size of 15-25 micrometers. The particles are highly agglomerated.

In order to make a slurry which will be used to coat the fluorescent lamp coils, the mixed carbonate powder is combined with a liquid medium. The liquid medium may be similar to that used in laquers and consists of an organic solvent, such as butyl acetate, or other low molecular weight acetate, and nitrocellulose, which is used as a thickener and binder. Other ingredients, such as alcohol, may also be added to achieve the desired viscosity. For example, a relatively small amount of the liquid medium is added to a ball mill containing alumina or zirconia milling media. The powder is then added to the ball mill. A slurry suitable for application to the coils is 40-65 wt %, more preferably, about 60 wt %, carbonate powder.

The carbonate powder may be added to the mill all at once or in stages, running the mill in between additions. For example, half of the desired amount of powder can be added to the liquid and milling media followed by a short running of the mill before the rest of the powder is added. This makes it easier to wet the powder during milling. After all the powder has been added to the mill, the ball mill is run for several of hours, generally about 5,000 to 20,000 revolutions, until the desired particle size is achieved. The median particle size is selected based on a number of criteria, including ability to coat the coils, lamp life, and absence of end-discoloration on the lamp. A median particle size of between 2.5-6 micrometers is used in one embodiment, as measured on a granulometer. In another embodiment, the median particle size is 3-5 micrometers. 2-5 wt % zirconia or zirconium metal may be added at any time during or after the milling. The slurry may be stored until needed.

It has now been found that in conventional fluorescent lamps, the activated emission mix forms a ceramic material which tends to fracture and break apart over time. Without intending to limit the scope of the invention, it is proposed that such failure may be due to the lamp being subjected to repeated thermal shock and thermal mismatch stresses associated with the heating of the coil during lamp starting. Mechanical stresses may also contribute to failure. Pieces of the emitter material eventually fall off the electrodes, resulting in eventual failure of the lamp. An investigation of the fracture and break up of the ceramic material in a conventional T8 lamp using scanning electron microscopy (SEM) revealed the rapid deterioration of the emitter material towards the end of the lamp life. The weight of emission material was also found to drop relatively slowly during the first two thirds of the lamp life, followed by a significantly faster drop thereafter. Another cause of reduced lifetime is due to the loss of emitter material due to evaporation and sputtering.

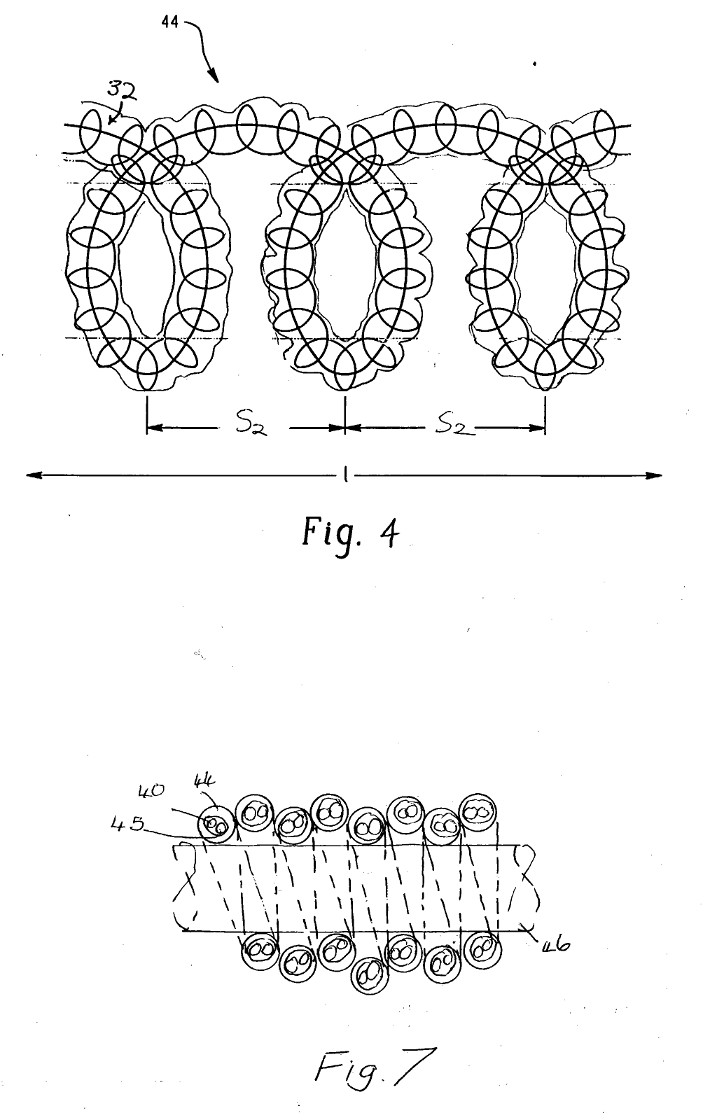

To address these problems and provide for longer lamp life, the present electrode has a larger amount of emitter material than in conventional lamps. In the embodiment shown in FIG. 4, the coil has a primary and a secondary coil structure (referred to herein as a “double coil” ). The secondary coiled structure is formed by winding the primary coiled structure.

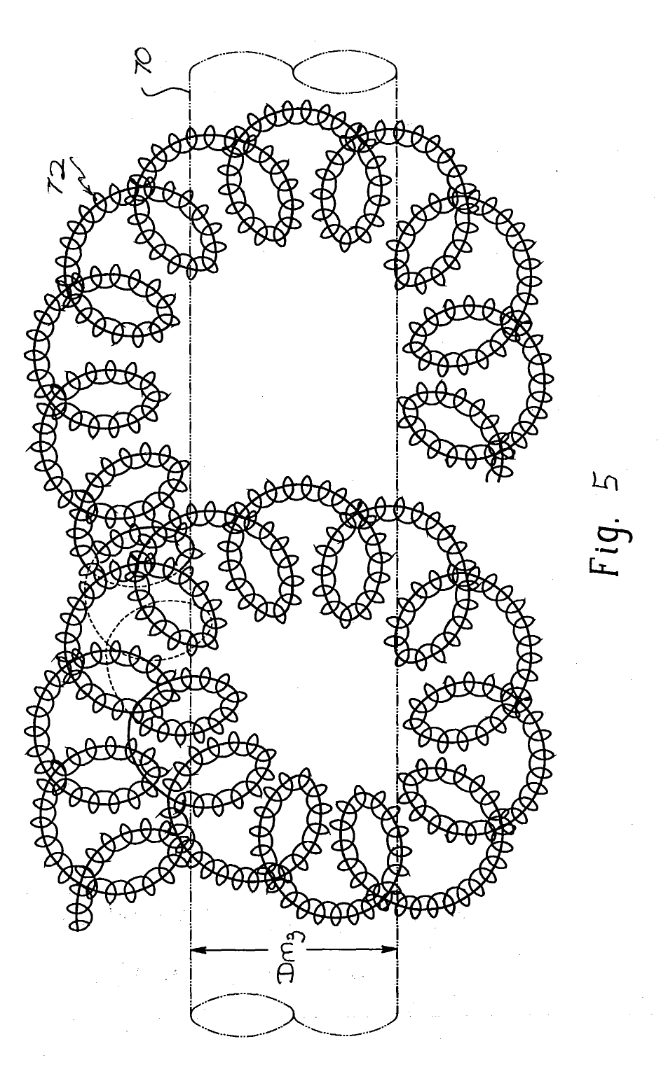

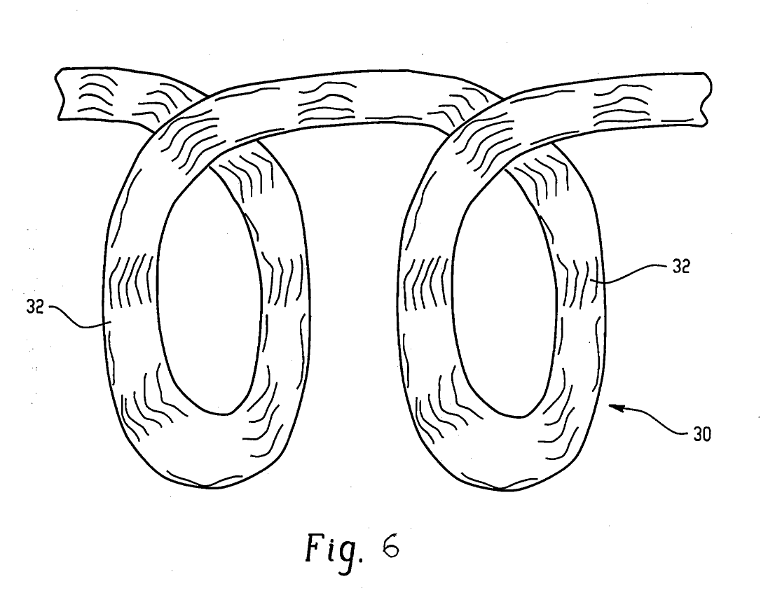

In another embodiment, shown in FIGS. 5-6, the coil has a tertiary coil structure, each of the secondary and tertiary coils being formed by winding the previous coil (referred to herein as a “triple coil”).

The lamp of either embodiment has a greater amount of emitter material than in a conventional lamp. In on embodiment, the lamp has about 50% more emitter than in a conventional lamp. The present double coil and triple coil may have 9-16 mg for a coil that has an overall length a of about 11.5 mm (see FIG. 1), i.e., about 0.78-1.39 mg of emitter per mm of coil length. Conventional triple wound coils used in T8 lamps, by comparison, usually have about 7-8 mg of emitter on a coil which is about 11.5 mm in overall length.

In the case of the embodiment of FIG. 4, the increase in emitter material is due to tighter winding of the secondary, and optionally also the primary coil. This provides a larger surface area for better adherence of the emission mix.

In the case of the embodiment of FIG. 5, the increase in emitter material is also due to the increased diameter of the tertiary mandrel and the longer length of the coil. In the case of the triple wound coil, the amount of emitter material which can be supported is also dependent on the length of the secondary coil (i.e., the length of the coil before winding to produce the tertiary coil structure). If too much emitter is added, the material fills the gaps (bridging) between the tertiary coils. As a result, the material is not readily activated.

The life of the lamp is dependent, at least in part, on the amount of emitter material. It has been found that there is an approximately linear relationship between amount of emitter and lamp life. Thus, it is desirable to achieve the maximum loading of emitter material which can be activated effectively.

With reference once more to the embodiment of FIGS. 2-4, the electrodes both have a double coil geometry. The coil 30 includes a current carrying wire 40, which can be about 1.5 to 3 mills (38-76 microns) in diameter Dw₁ and about 80-120 mm in length, more preferably, about 90-110 mm in length. An overwind wire 42 is coiled around the current carrying wire 40 to form a primary coil 44, as shown in FIG. 2. The overwind wire has a diameter Dw₂ of about 0.9-1.1 mills (22-28 microns) and is about 600-900 mm in length. A first generally cylindrical member such as a mandrel 45 (shown in phantom) is used to determine the width of each turn of the coil. Thus, the overwind wire is wound around both the mandrel and the current carrying wire. The first mandrel 45 may have a diameter Dm₁ of about 4-10 mills (102-254 microns). In one specific embodiment, the first mandrel has a diameter of 5-8 mills (127-203 microns). In another specific embodiment, the first mandrel has a diameter of about 6 mills (152 microns). The primary coil has a spacing s₁ which places the windings close together.

In one embodiment, the primary coil 44 is wound at about 300 TPI (TPI=1/s₁). For wire 42 of smaller diameter than 1.1 mills, the TPI of the primary coil is correspondingly larger, to maintain close spacing, and for wire 42 of larger diameter, the TPI is correspondingly smaller.

As shown in FIG. 3, the primary coil 44 (together with the mandrel 45 and current carrying wire 40) is then wrapped around a second generally cylindrical member, such as a second mandrel 46 (shown in phantom) to produce a secondary coil 47. The second mandrel may have a diameter Dm₂ of about 10-30 mills (254-762 microns). In one embodiment, the diameter of the second mandrel is about 15-25 mills (381-625 microns). In one specific embodiment, the diameter d₂ of the second mandrel is about 20 mills (508 microns). The secondary coil 47 has a closer spacing s₂ between each loop of the coil than is found in conventional cathodes.

The coil density of winding (or pitch ratio) S, is defined by the expression:

S=[h/s₂]×100 and is expressed as a percentage, where

h is the size of the turn and s₂ is the distance between centers of successive turns.

h=Dm₁+Dw₂+2Dw₁ and

s₂=1/TPI₂

where Dm₁ is the primary mandrel diameter in inches,

Dw₂ is the overwind wire diameter in inches,

Dw₁ is the current carrying wire diameter in inches, and

TPI₂ is the number of turns per inch in the secondary coil.

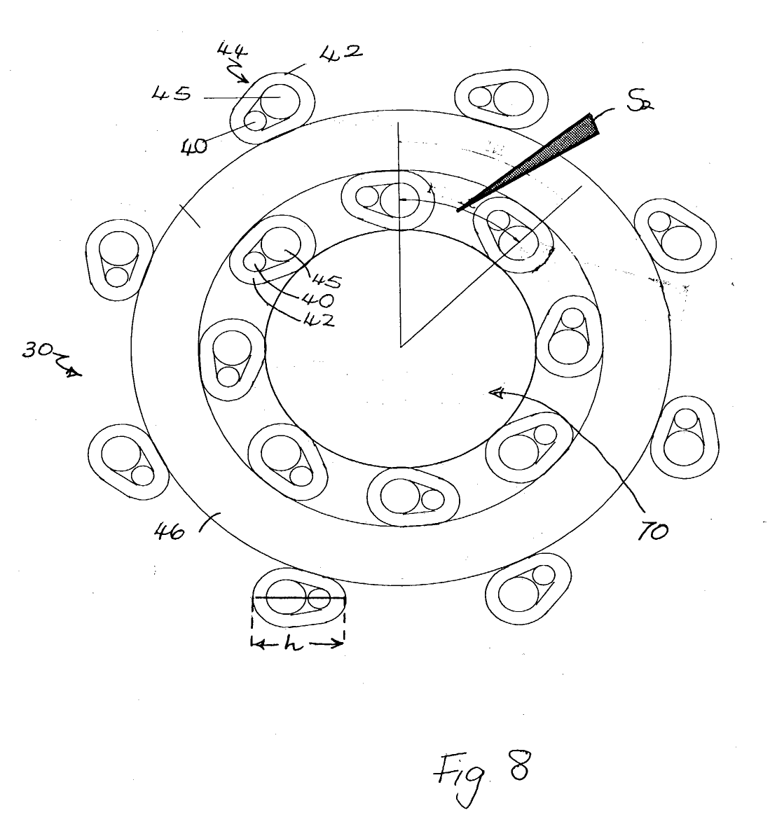

The rationale for using 2 times DW₁ can be seen by reference to FIG. 8, which shows a schematic cross section of one turn of a triple coil structure

Knowing Dm₁, Dw₂, Dw₁, TPI₂, the coil density can be determined. For example, if Dm₁ is 6 mills, Dw₂ is 2 mills, Dw₁ is 1 mill and TPI₂ is 100, the coil density is 100%. Preferably, the secondary coil 47 has a coil density which is at least 90%. In one embodiment, the coil density of the secondary coil is at least 95%, or at least 98%. In another embodiment, the coil density is 100%, or greater. 100% corresponds to complete coverage, with each turn in contact with the successive turn. To achieve a coil density of over 100%, there is necessarily some overlap between successive turns, as illustrated in cross section in FIG. 7. The coil density can be up to about 110%, or higher. In one embodiment, the coil density is about 95%-105%. In one specific embodiment, the coil density is about 100-102%.

To achieve such a high coil density, a TPI of 80 to about 300 (30-120 turns per cm) may be used for the secondary coil. In one embodiment at least 85 turns per inch is used (33 turns per cm). In another embodiment, the TPI is at least 90 (35 turns per cm). In one embodiment, the TPI is less than about 200 (80 turns per cm). For an overwind wire 42 of mills in diameter which has been wound around a primary mandrel of 6 mills in diameter and a current carrying wire 40 of 1 mill in diameter, a coil density of about 102-106% corresponds to a TPI of about 105 (41 turns per cm). This is significantly greater than in conventional lamps, where the TPI is about 60. The secondary coil has an overall length l, when formed, of about 8-15 mm, which, in this embodiment, corresponds to the length a of the coil. In one embodiment, a is about 11.5 mm.

The two mandrels are preferably removed, after forming the coiled structure, by dissolving the mandrels away in an acid bath.

The secondary coil thus formed is then coated with an emitter material, as described above. Specifically, the coil is coated with a slurry of (Ba, Ca, Sr)CO₃ or other suitable emitter slurry, which forms the emitter material when activated. The amount of the triple carbonate material which can be supported on the coil is preferably from 9 to 16 mg (this is for a coil of 10-12 mm in finished length). This is equivalent to about 0.6-1.6 mg per mm length of coil. For shorter or longer coils, the amount of emitter material will vary accordingly.

In one embodiment, the length l of the secondary coil is increased, prior to applying the emitter material, for example by stretching the coil. This increases the spacing between successive windings, allowing the emitter material to penetrate between the windings. In one embodiment, the coil is extended until the coil density is less than 100%. In one specific embodiment, the secondary coil is stretched until the coil density is about 95%, or less. For example, the coil density may drop from a range of from about 95% to about 105%, before stretching, to a range of from about 70% to 90%, after stretching. The overall increase in the length produced by the stretching may be from about 2% to about 35%. In one embodiment, the secondary coil is stretched by at least 5%. In another embodiment, the coil increases in length by at least 10%. In another embodiment, the secondary coil is stretched by up to about 20%. Once the emitter material has been applied, the tension on the coil can be released. The emitter material is retained between the windings. The length of the coil may shrink again somewhat once the tension is released.

It has been found that using a high coil density and then stretching the coil prior to application of the emitter serves several purposes. First, it provides a large surface area of coil over which the emitter is distributed, increasing the amount of emitter material which can be retained. Second, it opens the structure to allow the emitter to penetrate between the turns of the coil, so that all surfaces of the coil can be made accessible to the emitter. Third, the tension in the wire also helps to grip the applied emitter, reducing the likelihood of spalling.

It will be appreciated that the maximum coil density at which the emitter material can still penetrate readily between the windings is dependent, to some degree, on the size of the particles which make up the emitter material slurry. Although the emitter material may have a median particle size of about 3-5 microns, larger particles in the mix may be up to about 15 or 20 microns in diameter. To accommodate the larger particles, the open space between windings w₂ (after any stretching has taken place) is preferably about 20 microns, or greater. It will be appreciated that the spacing between the windings can be smaller if the particle size distribution is tighter, or if a smaller median size is used.

The electrode thus formed is suitable for use as a cathode/anode in fluorescent lamps of from about 1″ to 1½″ (2.5-3.8 cm) in diameter, such as lamps commonly referred to as T8 and T12. The coil 30 is mounted to the base by first and second electrically conductive supports 60, 62 such that the coil is arranged generally perpendicular to the tube length. The glass tube is preferably coated on the inside with a fine alumina powder which serves as a UV reflecting coating. After drying the alumina coating, the tube is coated with a slurry containing a rare earth phosphor powder blend, halophosphate phosphor blend, or other selected phosphor material. Alternative UV reflecting coatings and phosphor coatings are also contemplated.

The electrodes are sealed into ends of the tube and the tube exhausted as is commonly known before being dosed with a small amount of mercury and filled with the selected inert gas.

The double coil electrode is suited to use with both instant start and rapid start ballasts. A comparison of lamps formed with the double coil electrode described above show at least about a 50% improvement in the number of cycles (switching on then off) that the lamp can withstand before failure over currently manufactured lamps. Whereas conventional lamps with an instant start ballast may withstand about 10,000 to 13,500 cycles, the present lamps have been found to last 18,000 to 21,000 cycles, or more. In addition to the ability to withstand rapid cycling tests, the lamps formed have a longer useful life than conventional lamps. For example with an instant start ballast, the lamp may have a lifetime of about 20,000-24,000 hours, on a standard three hour cycle (three hours on twenty minutes off), which compares with about 15,000 hours for conventional lamps on instant start ballasts. The coil is also suited to use in lamps with a rapid start ballast, where even longer lifetimes may be achieved.

In one embodiment, the coil is used in a T8 or T12 lamp. Lamps of this type include GE's F32T8 Ultra Watt Miser and Ultra Watt Miser XL. The lamp can be used on both instant and rapid start ballasts, without the need for modification. This allows a user or retailer to reduce the types of lamps stocked by half.

In the embodiment of FIGS. 5-6, a triple coil structure is used in place of the double coil structure of FIGS. 2-4. This structure is similar to that described above, but with a third coil being formed, in addition to the primary and secondary coils. The first and second coils can be formed in a similar manner to that described above. In this embodiment, the secondary coil 47 has an overall length l, when formed, of about 20-40 mm. In one specific embodiment, 1 is about 30 mm.

The secondary coil 47 is then wound around a third cylindrical member, such as a third mandrel 70 to produce a tertiary coil 72 as shown in FIG. 5. The diameter Dm₃ of the third mandrel is preferably at least 1 mm, more preferably, 1-2 mm, and most preferably, 1.2 to 1.55 mm. This compares with about 0.8 mm for a conventional cathode. The third mandrel could be larger than 2 mm. However, at some point the coil loses its structural integrity. FIG. 7 illustrates the coiling schematically. As with the double coil structure, the coil density of the secondary coil is an important factor in determining to amount of emitter retained and the strength of the retention and can be the same as that described above for the double coil structure.

The three mandrels are preferably removed, after forming the coiled structure, by dissolving the mandrels away in an acid bath.

As a result of the increased diameter of the third mandrel, the coil length l (i.e., the effective length of the secondary coil before winding to form the third coil) is about 50% longer than in a conventional fluorescent lamp. Since the amount of emitter material the coil can support is proportional to the length l of the coil, a 50% increase in secondary coil length l generally results in about 50% more emitter material and a correspondingly longer tube life (about 50% longer). An increase in TPI of the second coiled structure has also been found to lead to increased lamp life by holding the emitter material onto the cage-like structure of the coil for a longer period of time. By combining both of these features in the coil, lifetimes of about double current to standard lamp lifetimes may be achieved.

The coil when formed need not be stretched prior to application of the emitter material because the process of forming the tertiary coil causes an increase in the spacing of the secondary coil turns at their outer edges (corresponding to the outer periphery of the tertiary coil), while the secondary coil turns may be caused to overlap on the inner edges. This spacing allows the emitter material to penetrate into the coil structure.

The coil thus formed is coated with a slurry of (Ba, Ca, Sr)CO₃ or other suitable emitter slurry, which forms the emitter material when activated. The amount of the triple carbonate material which can be supported on the coil is preferably from 9 to 16 mg (this is for a coil of 10-12 mm in finished length for shorter or longer coils, the amount of emitter material will vary accordingly).

The electrode thus formed is suitable for use as a cathode/anode in fluorescent lamps of from about 1″ to 1½″ (2.5-3.8 cm) in diameter, such as T8 and T12 lamps, as described above for the coil of FIGS. 2-4. While the triple coil may be used in both instant and rapid start systems, it is best suited to use with instant start ballasts.

The following examples indicate the improvements in lamp life which can be made.

### EXAMPLES

### Example 1

Fluorescent lamps were formed using double coil and triple coil electrodes prepared as described above. The secondary coil was stretched by up to about 20% prior to applying a slurry comprising a about 60 wt %, carbonate powder (50 wt % equivalent barium carbonate, 40 wt % equivalent strontium carbonate and 10 wt % equivalent calcium carbonate).

The properties of the coil were as shown in Table 1.

TABLE 1

| | Double Coil | Triple Coil |
|---|---|---|
| Overwind Wire Diameter (microns) | 1 | 1 |
| Current Carrying Wire Diameter (microns) | 2 | 2.4 |
| Primary Mandrel diameter (microns) | 152 (6 mills) | 152 (6 mills) |
| TPI- Primary Mandrel | 300 | 250 |
| Secondary mandrel Diameter (microns) | 508 (20 mills) | 152 (6 mills) |
| TPI- Secondary Mandrel | 100 | 92 |
| Coil density % (secondary mandrel), prior | 100 | 96 |
| to stretching | | |
| Diameter of tertiary mandrel (mm) | — | 1.35 |
| Length of coil after winding (mm) | 13 | 13 |
| Amount of emitter material (mg) | 9 | 10.5 |

T8 lamps were formed using electrodes thus formed. The lamps were filled with a fill of argon at a fill pressure of 2.1 Torr and 2.5 Torr.

Rapid cycle testing was carried out on the lamps using both instant start ballasts. The tests were performed using a one minute on, one minute off cycle and the number of cycles (on and off) before failure was determined. The results were as follows: Table 2 shows the results using an instant start ballast for several lamps of each type.

The results are compared in Table 2 with those for three commercial F32T8 lamps, labeled A, B, and C, under the same cycle conditions.

TABLE 2

| | Inventive | Inventive | A | B | C |
|---|---|---|---|---|---|
| | Double | Triple | (triple | (double | (double |
| Lamp | Coil | Coil | coil) | coil) | coil) |
| Fill Pressure (Torr) | 2.5 | 2.1 | 2.5 | 2.4 | 2.7 |
| Coil Density | 100 | 96 | 85 | 90 | 91 |
| Mean Cycles to | 21000 | 9000 | 6000 | 12000 | 13500 |
| Failure (Instant | | | | | |
| Start) | | | | | |

As can be seen, the lamps of the present invention performed well in instant start systems, out-performing the commercial lamps, even at lower fill pressure.

### Example 2

Computer modeling was used to predict the lifetimes of the coil on rapid start circuits using the transfer function. The transfer function describes the relation between the lamp life and the burn cycle. The transfer function assumes the same amount of emission material is consumed at each lamp start and constant or variable emission mix consumption rate at continuous burn. The effect of the lamp start can be neglected in the case of rapid start lamp operation. The emission mix loss will occur only due to evaporation during the continuous burn. Generally, increasing emission mix weight lamp life increases at the same emission mix loss rate measured in milligrams per thousand hours.

### Example 3

Cathode coils of a triple coil structure for use in T8 lamps were formed with different coil parameters, such as current carrying wire diameter, overwind wire pitch, secondary coil pitch, and tertiary mandrel diameter. All variables were used in a 24 factorial design of experiments to determine which, if any of these parameters, had beneficial results. The results indicate that the most important parameters for determining the emitter mass and the number of starts in a rapid cycle test were the third mandrel diameter and the second mandrel turns per inch (TPI). Emitter mass was determined by weighing samples of the coil with the dried emitter coating and then removing the coating in a vibrating water/acid bath and reweighing.

Rapid cycle tests were performed by turning the lamp on and off either on a 1 minute on, 1 minute off cycle, or a 5-minute on, 5 minute off cycle. Both experiments were done on eight lamps in each cell of the design of experiments. The number of starts before failure was recorded.

Table 3 summarizes the expected life increase based on increase in emitter mass and on the number of rapid cycle starts. The table shows the effect of increasing the 2nd mandrel TPI from 68.6 of 89.9 TPI and increasing the 3rd mandrel diameter from 0.86 mm to 1.25 mm diameter. These results are for the 5-minute on, 5 minute off cycle.

TABLE 3

| | | Mass of | | | | |
|---|---|---|---|---|---|---|
| | Original | Emitter | Expected Life | | | Expected Life |
| | Mass of | material | Increase | Original | Number of | Increase |
| | Emitter | for Change | Based On | Number | Rapid Cycle | Based On |
| | material | in Coil | Emitter Mass | of Rapid | Starts for | Increase in |
| | (mg) | (mg) | Increase | Cycle Starts | Change in Coil | Rapid Cycle Starts |
| Longer cathode - | 7.5 | 10.5 | ˜+40% | 4000 | 6300 | ˜+60% |
| increased 3^{rd} | | | | | | |
| mandrel from 0.86 | | | | | | |
| mm to 1.25 mm | | | | | | |
| Tighter cathode - | 7.5 | 9.0 | ˜+20% | 4000 | 6800 | ˜+70% |
| 2^{nd} mandrel TPI | | | | | | |
| increased from | | | | | | |
| 68.6 to 89.9 | | | | | | |
| Longer cathode - | 7.5 | 12 | ˜+60 | 4000 | 8800 | ˜+120 |
| increased 3^{rd} | | | | | | |
| mandrel from 0.86 | | | | | | |
| mm to 1.25 mm and | | | | | | |
| tighter cathode- | | | | | | |
| 2^{nd} mandrel TPI | | | | | | |
| increased from | | | | | | |
| 68.6 to 89.9 | | | | | | |

The 1-minute on/off cycle showed similar results, with a value of 9000 in place of the 8800 being obtained for the 5 minute cycle. The results show large and unexpected improvements in lamp life.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A discharge lamp comprising:
an envelope;
a discharge-sustaining fill sealed inside the envelope;
first and second electrodes for providing a discharge, at least the first electrode including a current carrying wire and a coil including at least first and second coiled structures:
the first coiled structure formed by winding an overwind wire around a first cylindrical member,
the second coiled structure formed by winding the first coiled structure around a second cylindrical member, the second coiled structure having a coil density of at least 95%; and
an emitter material deposited on the coil.

2. The discharge lamp of claim 1, wherein the coil density of second coiled structure is about 100%.

3. The discharge lamp of claim 1, wherein the coil density of second coiled structure is over 100%.

4. The discharge lamp of claim 1, wherein the second coiled structure has at least 80 turns per inch.

5. The discharge lamp of claim 4, wherein the first coiled structure has at least 200 turns per inch.

6. The discharge lamp of claim 5, wherein the first coiled structure has about 300 turns per inch.

7. The discharge lamp of claim 1, wherein the coil further includes a third coiled structure formed by winding the second coiled structure around a third cylindrical member.

8. The discharge lamp of claim 7, wherein the third cylindrical member has a diameter of at least 1.0 mm.

9. The discharge lamp of claim 1, wherein the third cylindrical member has a diameter of at least 1.2 mm.

10. The discharge lamp of claim 1, wherein the coil is at least 10 mm in length.

11. The discharge lamp of claim 1, wherein the emitter material comprises an oxide selected from the group consisting of barium, strontium, calcium, zirconium, and combinations thereof.

12. The discharge lamp of claim 1, wherein the amount of emitter material is 0.6-1.6 mg/mm length of the coil.

13. A method for forming a coil for a fluorescent lamp, the method comprising:
forming a coil including:
winding an overwind wire around a current carrying wire to form a first coiled structure,
winding the first coiled structure around a cylindrical member to form a second coiled structure, the second coiled structure having a coil density of at least 95%; and
coating the coil with an emitter mix which, when activated, emits electrons when heated.

14. The method of claim 13, further comprising:
stretching the coil prior to the step of coating with the emitter mix to increase a length of the second coiled structure.

15. The method of claim 14, wherein the step of stretching includes:
stretching the second coiled structure until the coil has a coil density of less than 100.

16. The method of claim 14, wherein the step of stretching includes:
stretching the second coiled structure until the coil has a coil density of less than about 95%.

17. The method of claim 14, wherein the step of stretching includes:
stretching the second coiled structure to increase its length by at least 2%.

18. The method of claim 17, wherein the step of stretching includes:
stretching the second coiled structure to increase its length by at least 5%.

19. The method of claim 17, wherein the step of stretching includes:
stretching the second coiled structure to increase its length by up to about 20%.

20. The method of claim 13, further including:
increasing a length of the coil prior to the step of coating such that a spacing between turns of the secondary coil is greater than the diameter of 90% of particles in the emitter mix.

21. The method of claim 13, wherein the step of forming a coiled structure further includes winding the second coiled structure around a second cylindrical member to form a third coiled structure, the second cylindrical member having a diameter of at least 1 mm.

22. An electrode which includes a coil formed by the method of claim 13.

23. A fluorescent lamp which includes an electrode coil formed by the method of claim 13.

24. A method for forming a coil for a fluorescent lamp, the method comprising:
forming a coil including:
winding an overwind wire to form a first coiled structure,
winding the first coiled structure around a cylindrical member to form a second coiled structure of a first coil density, and
extending the second coiled structure to form a coil having a second coil density which is less than the first coil density; and
coating the extended coil with an emitter mix which, when activated, emits electrons when heated.
